(19) United States
(12) Patent Application Publication
(10) Pub. No.: US 2024/0000646 A1
(43) Pub. Date: Jan. 4, 2024

(54) CONVERTIBLE WEIGHTED BLANKET FOR LAW ENFORCEMENT USE

(71) Applicant: Israel Reyes, III, Hialeah, FL (US)

(72) Inventor: Israel Reyes, III, Hialeah, FL (US)

(21) Appl. No.: 17/855,643

(22) Filed: Jun. 30, 2022

(51) Int. Cl. A61G 17/06

(52) U.S. Cl. CPC A61G 17/06

(57) ABSTRACT

An improved blanket for covering a deceased person's body, comprising a weighted-perimeter with a fluid-absorbable material on a bottom layer and a waterproof material on a top layer; a plurality of reflective patches on the top layer; printed information on the top layer (i.e., name of the police/fire/EMS department); a heavy-duty zipper for converting the blanket into a body bag, and 2-4 handles used for carrying the body bag.

### TECHNICAL FIELD

The embodiments generally relate to wind-resistant blankets or tarps used by law enforcement to cover a deceased person's body.

### BACKGROUND

Currently, law enforcement officers, Firefighters, Paramedics, EMT's, and crime scene personnel responding to a call involving a deceased person use a plastic tarp to cover the deceased person's body, to protect the identity of the deceased person, and to prevent photographs from being taken of the body. Thin, plastic tarps have a problem is that they can easily blow away in the wind. Hence, there is a need for a waterproof blanket or covering that doesn't blow away in the wind. Also, it would be desirable to include a fluid-absorbable material on the underside of the blanket to absorb bodily fluids, if any. Finally, it would be desirable to be able to convert the blanket into a body bag for carrying the deceased body.

### SUMMARY

An improved blanket for covering a deceased person's body, comprising a weighted-perimeter with a fluid-absorbable material on a bottom layer and a waterproof material on a top layer; a plurality of reflective patches disposed on the top layer; optional printed information on the top layer (i.e., name of the police/fire/EMS department); a heavy-duty zipper for converting the blanket into a body bag, and two to four or more handles for carrying the body bag.

### BRIEF DESCRIPTION OF THE DRAWINGS

FIG. 1 shows a plan view of a first example of a weighted blanket, according to the present invention.

FIG. 2 shows a cross-section view (Sec. A-A) of a first example of a weighted blanket, according to the present invention.

FIG. 3 shows a plan view of a second example of a weighted blanket with reflective patches, according to the present invention.

FIG. 4 shows a plan view of a third example of a weighted blanket with reflective stripes, according to the present invention.

FIG. 5 shows a cross-section view (Sec. A-A) of a fourth example of a weighted blanket comprising a 2-ply layer, according to the present invention.

FIG. 6 shows a cross-section view (Sec. A-A) of a fifth example of a weighted blanket comprising a 3-ply layer, according to the present invention.

FIG. 7 shows a cross-section view (Sec. A-A) of a sixth example of a weighted blanket comprising a fiber-reinforced plastic layer, according to the present invention.

FIG. 8 shows a plan view of a seventh example of a weighted blanket with attached handles and a heavy-duty zipper, according to the present invention.

FIG. 9 shows a cross-section view (Sec. B-B) of an eighth example of a weighted blanket comprising a heavy-duty zipper around the blanket's perimeter, according to the present invention.

### DETAILED DESCRIPTION

The present invention comprises a waterproof, perimeter-weighted blanket for use by law enforcement officers, firefighters, EMS personnel, paramedics, EMT's and Crime Scene officers. The purpose of the blanket is to protect the identity of the deceased in a public setting from exposure to the media and onlookers.

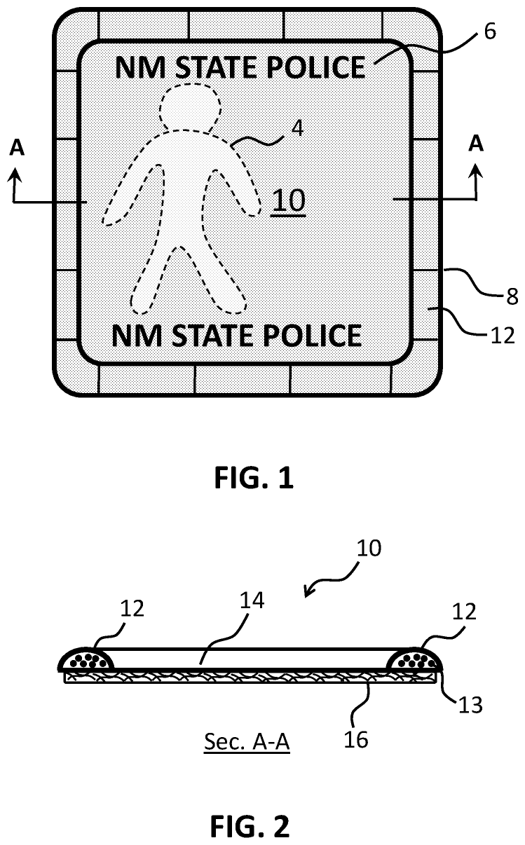

FIG. 1 shows a plan view of a first example of a weighted blanket 10, according to the present invention. The blanket/tarp 10 can have a square or rectangular shape. In a square shape, the blanket can be 7 ft×7 ft. In a rectangular shape, the blanket can be 4 ft×7 ft in size, for example, sufficient to completely cover a deceased body 4.

FIG. 2 shows a cross-section view (Sec. A-A) of a first example of a weighted blanket 10, according to the present invention. The edges of the blanket are hemmed, with a hem 8 and the hemmed region 12 is filled with a dense, heavy material 13. The dense, heavy material 13 can be a gel-like material, or a granular material like sand, BB-balls, steel balls, steel rods, steel strips, or tungsten balls. The dense material 13 can have a density greater than or equal to about 7 gm/cm³. The weighted blanket 10 has a top layer 14 and an opposing bottom layer 16 with different materials on the two different layers.

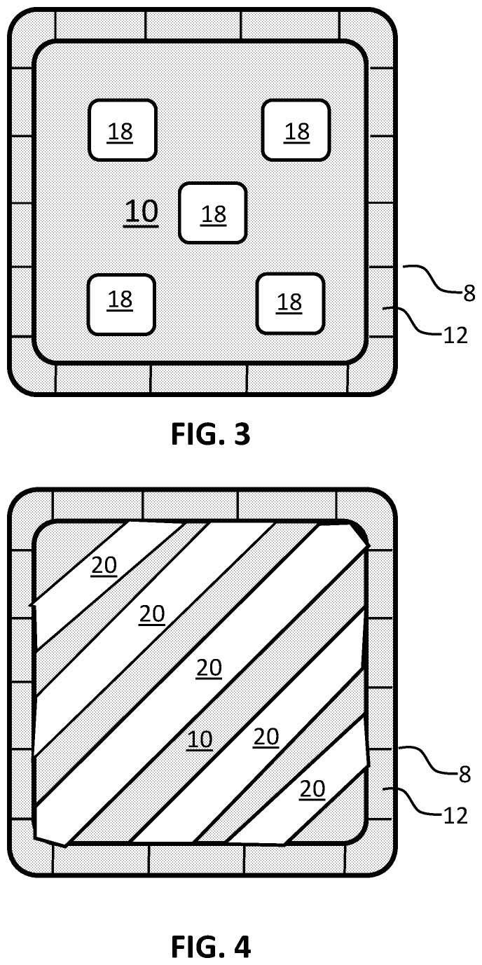

FIG. 3 shows a plan view of a second example of a weighted blanket 10 with reflective patches 18, according to the present invention. The top side comprises a continuous, waterproof plastic material 14 (such as Mylar™, polyethylene, polyurethane, or equivalent waterproof polymeric material) that optionally can be colored bright orange or lime green, or partially covered with orange/green stripes of a sticky tape adhesively attached to the top layer.

FIG. 4 shows a plan view of a third example of a weighted blanket 10 with reflective stripes, according to the present invention. The top layer can optionally comprise a plurality of silverly reflective stripes 20. The bottom layer comprises a water/fluid-absorbing, felted or woven or spun material 16 similar to those used in infant or adult diapers, which is bonded at multiple places to the blanket's top side. Materials used for the absorbent bottom layer can be selected from the group consisting of natural cotton, polypropylene, and sodium polyacrylate.

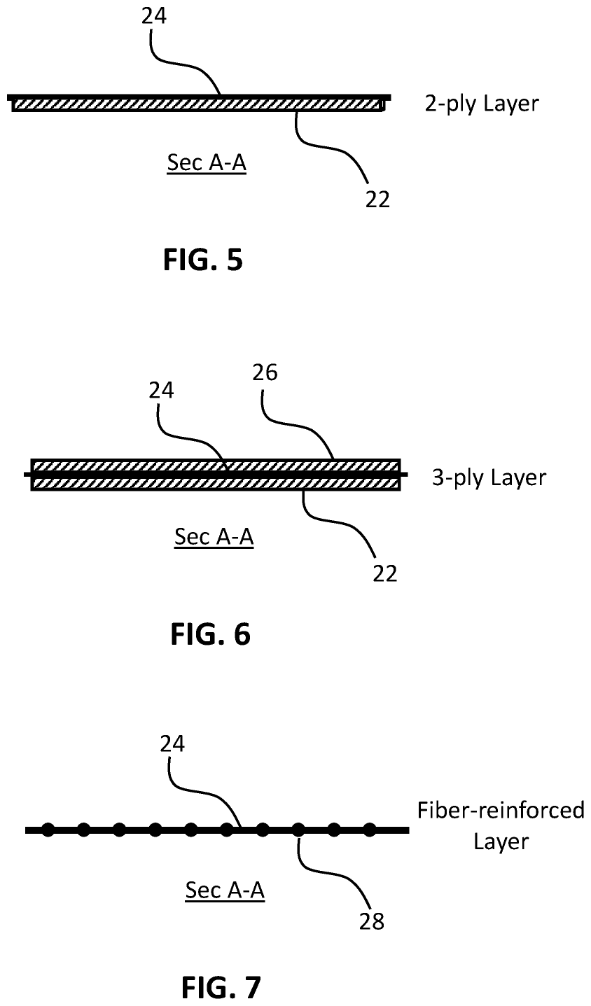

FIG. 5 shows a cross-section view (Sec. A-A) of a fourth example of a weighted blanket 10 comprising a 2-ply layer, according to the present invention. Alternatively, the top layer 14 can additionally comprise a woven, cloth-like material used primarily for strength (e.g., made from Nylon™ or Kevlar™ or Spectra™ or other fiber to increase the tear strength of the blanket). Alternatively, the top layer can be made of a composite of two layers, (two-ply), with one ply comprising a thin, waterproof plastic sheet of material 24, and the other ply comprising a thicker, woven, cloth-like material 22 primarily for strength. The top ply 24 can be bonded to the cloth-like lower ply 22, with, for example, ultrasonic (friction) spot welding.

FIG. 6 shows a cross-section view (Sec. A-A) of a fifth example of a weighted blanket 10 comprising a 3-ply layer, according to the present invention. The inner ply 24 is made of a waterproof plastic material, while the upper ply 26 and the lower ply 22 are made of a thicker, woven, cloth-like material used primarily for strength. The top ply 24 can be bonded to the cloth-like lower ply 22 and upper ply 26, with, for example, ultrasonic (friction) spot welding.

FIG. 7 shows a cross-section view (Sec. A-A) of a sixth example of a weighted blanket 10 comprising a fiber-reinforced plastic layer, according to the present invention. Alternatively, the top layer can be made of a fiber-reinforced, anti-tear, square/rectangular or hexagonal mesh of high-strength polymeric fibers encased or embedded in a continuous plastic substrate.

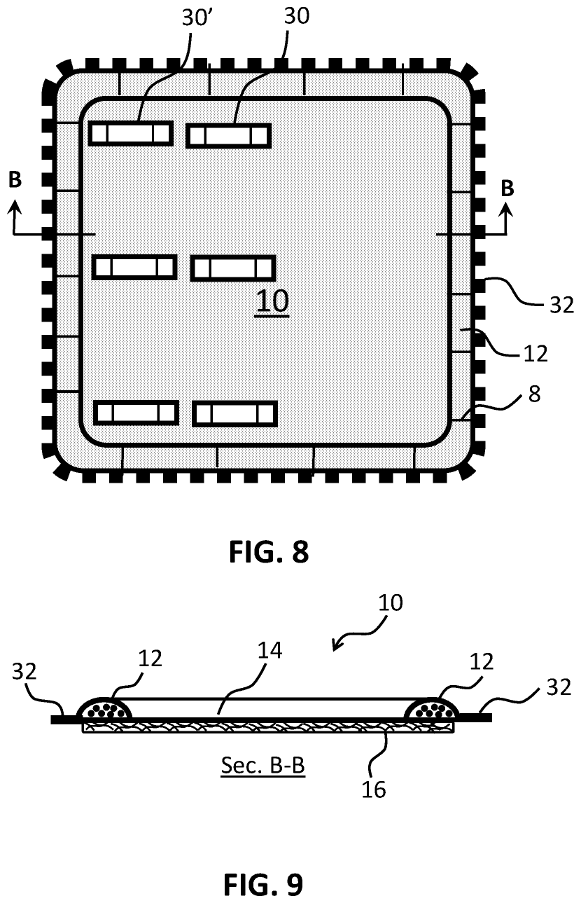

FIG. 8 shows a plan view of a seventh example of a weighted blanket 10 with 4 attached handles 30, 30′ and a heavy-duty zipper 32, according to the present invention. Optionally, a heavy-duty zipper 32 can be placed around the perimeter 12 of the blanket 10, in order to turn the blanket into a sealed body-bag. Alternatively, a plurality of 2-4 handles 30, 30′ (e.g., made of, or reinforced with, Nylon™ or Kevlar™ fabric) can be attached by sewing the handles 30, 30′ to the blanket 10 to make carrying the deceased body 4 easier when the blanket 10 used as a body bag.

The weighted blanket 10 of the present invention can also be used as a thermal blanket for living subjects exposed to cold weather. Also, the width of the hemmed perimeter 12 can range from 2″ to 4″, depending on the density of the dense material filling the hemmed region 12.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A weighted blanket, for use by police officers, paramedics, EMTs, FBI, or Crime Scene Personnel when covering up a deceased body, comprising:
a top layer attached to a bottom layer;
wherein the top layer comprises a waterproof plastic material,
wherein the bottom layer comprises a fluid-absorbable material, and
wherein the blanket further comprises a weighted perimeter.

2. The weighted blanket of claim 1, wherein the weighted perimeter comprises a hemmed region containing a dense material having a density of at least 7 gm/cm³.

3. The weighted blanket of claim 1, wherein the dense material is selected from the group consisting of a gel-like material, metallic balls, tungsten balls, steel balls, steel rods, and steel strips, and water-filled or sand-filled sealed plastic bags.

4. The weighted blanket of claim 2, wherein the width of the hemmed region of the blanket ranges from 2″ to 4″.

5. The weighted blanket of claim 1, wherein the waterproof plastic top layer comprises a material selected from the group consisting of Mylar™, polyethylene, polypropylene, and a polymeric material.

6. The weighted blanket of claim 1, wherein a top surface of the top layer further comprises an orange or lime green color.

7. The weighted blanket of claim 1, wherein a top surface of the top layer further comprises a plurality of reflective stripes or patches comprising a reflective material.

8. The weighted blanket of claim 7, wherein the reflective stripes or patches comprise silverized Mylar™ that is adhesively bonded, ultrasonically-bonded, or heat-bonded to the top layer.

9. The weighted blanket of claim 1, wherein the top layer further comprises a two-ply layer comprising a woven, high-strength, cloth-like material attached to the waterproof layer.

10. The weighted blanket of claim 9, wherein the cloth-like material is selected from the group of high-strength polymeric fibers consisting of woven Kevlar™, woven Nylon™, and woven Spectra™.

11. The weighted blanket of claim 1, wherein the top layer further comprises a three-ply construction comprising: a thin inner layer of waterproof plastic sandwiched in-between two plies of woven, high-strength, cloth-like material/

12. The weighted blanket of claim 1, wherein the bottom layer comprises a fluid-absorbable material selected from the group consisting of natural cotton; woven, felted, or spun polypropylene; and woven, felted, or spun sodium polyacrylate.

13. The weighted blanket of claim 1, wherein the top layer comprises a rectangular, square, or hexagonal mesh of high-strength polymeric fibers embedded in a continuous plastic substrate.

14. The weighted blanket of claim 13, wherein the polymeric fibers are selected from the group consisting of Kevlar™ fibers, Spectra™ fibers, and Nylon™ fibers.

15. The weighted blanket of claim 1, further comprising from 2 to 4 handles coupled with the blanket.

16. The weighted blanket of claim 1, further comprising an alphanumeric title disposed on top of the blanket, comprising an agency or department name.

17. A weighted blanket, for use by police officers, paramedics, EMTs, or Crime Scene Personnel, comprising:
a top layer attached to a bottom layer;
a weighted perimeter including a heavy-duty zipper disposed around the weighted perimeter of the blanket;
and 2-4 carrying handles,
wherein the top layer comprises a waterproof plastic material, and
wherein the bottom layer comprises a fluid-absorbable material.

18. The weighted blanket of claim 17 wherein the blanket has a square shape measuring about seven feet by seven feet.

19. The weighted blanket of claim 17, wherein the blanket has a rectangular shape measuring about four feet by seven feet.

20. A weighted blanket, for use by police officers, paramedics, EMTs, or Crime Scene Personnel, comprising:
a perimeter weighted with a plurality of steel balls or steel strips and having a heavy-duty zipper disposed around the perimeter; and
a top layer coupled to a bottom layer,
wherein the top layer comprises a waterproof plastic layer,
wherein the top layer is colored orange or lime green,
wherein the top layer comprises reflective patches or stripes on the top layer's outer, upper surface,
wherein the top layer comprises two or four carrying handles,
wherein the top layer comprises a rectangular, square, or hexagonal mesh of high-strength polymeric fibers embedded in a continuous plastic substrate, and
wherein the bottom layer comprises a fluid-absorbable material.
